(19) United States
(12) Patent Application Publication
(10) Pub. No.: US 2022/0248899 A1
(43) Pub. Date: Aug. 11, 2022

(54) COOKWARE SET WITH LID HOOK

(71) Applicant: E. MISHAN & SONS, INC., New York, NY (US)

(72) Inventor: Enoch Lam, Hong Kong (CN)

(73) Assignee: E. MISHAN & SONS, INC., NEW YORK, NY (US)

(21) Appl. No.: 17/731,767

(22) Filed: Apr. 28, 2022

Related U.S. Application Data
(63) Continuation of application No. 29/832,258, filed on Mar. 25, 2022.

(51) Int. Cl. A47J 36/12

(52) U.S. Cl. CPC A47J 36/12

(57) ABSTRACT

A cookware set comprises a cookware vessel having a rim, a lid having an edge and a center, the lid configured to fit on and cover the cookware vessel in a first position, and a lid hook disposed on an upper surface of the lid at or near the edge of the lid and configured to support the lid in a substantially vertical position on a rim of the cookware vessel in a second position. The lid hook comprises a base member attached to the lid and an upper member extending over base member to define a cavity therebetween for receiving the rim of the cookware vessel. The cavity has an outer portion disposed toward the edge of the lid and an inner portion disposed toward the center of the lid, the cavity having a first gap between the base member and the upper member which is wide at the outer portion and narrow at the inner portion. A tongue disposed in the cavity on the base member defining a second gap between the tongue and the upper member. The cavity, first gap, and second gap are configured to guide the edge of the lid to a stable resting position so that the lid is supported on the rim of the cookware vessel in a second position.

### CROSS-REFERENCE TO RELATED APPLICATIONS

This application is a continuation of U.S. patent application Ser. No. 29/832,258, filed Mar. 25, 2022, the entirety of which is hereby incorporated by reference for all purposes.

### FIELD AND BACKGROUND OF THE SUBJECT TECHNOLOGY

The subject technology relates to cookware, including household or commercial cookware, more particularly to pots and pans with lids.

A person using cookware will often have a need to remove the lid of a pot or pan while cooking. This requires the user to find a place to temporarily stow the lid while, for example, stirring the contents or adding ingredients. Setting the lid aside on a countertop may result in soiling the countertop with material that may be on the lid.

There is a need to provide some means to temporarily stow a removable lid during cooking, within easy reach of the user, without soiling nearby surfaces.

### SUMMARY OF THE SUBJECT TECHNOLOGY

According to an aspect of the subject technology, a cookware set comprising a cookware vessel (such as a pot or pan) and a lid is provided. The lid has a lid hook attached at or near the edge of the lid for safely and temporarily supporting the lid on the rim of the vessel. The lid hook is configured and disposed so that the lid is supportable in a substantially vertical position on the edge of the vessel, with the bottom of the lid facing inwards, and a lower portion of the lid below the rim of the vessel, so that any material dripping or falling off the lid will end up in the pot.

In the non-limiting embodiment of the subject technology shown in the Figures, a lid hook is attached to a cookware lid, adjacent the edge of a cookware lid, and has the following structure. The lid hook is in the form of a unitary block of, for example, metal, polymer, or more especially heat-resistant polymer and may be formed by molding, casting, 3D printing, or any other suitable method of manufacture.

The lid hook is generally wedge-shaped and is formed with a cavity, which is open on an edge of the lid hook adjacent to the edge of the lid. The cavity has an outer portion (toward the edge of the lid) and an inner portion (toward the center of the lid).

The cavity has a first gap between a base member or floor (attached to the lid by a fastener, or adhesive, or other suitable means) and an upper member or roof extending over the base member, with the first gap therebetween. The first gap has a width (in the vertical direction between the base member and upper member) which is wider in the outer portion and narrower in the inner portion, so that it is easy for the user to initially place the lid hook over the rim of the cookware item (because the outer portion of the first gap is relatively wide and is an easy target). The cavity is curved to accommodate the curvature of the cookware rim. In the embodiment shown, the upper member has an inner surface which curves upward, and the base member has an inner surface which curves downward, thereby achieving the first gap as described. As the lid settles down on the rim of the cookware item, the rim is introduced into the inner portion of the lid hook which has a narrower gap, and thus the inner surfaces of the base member and upper member guide the lid into a support position which is a stable position on the rim.

In the embodiment shown, a tongue is disposed within the cavity, located on a center line of the base portion, and which is narrower in width than the base portion, and which defines a second gap between an upper surface of the tongue and the inner surface of the upper member. The tongue has angled edges on the left and right sides, as shown, which tend to guide the rim into the narrowest part of the first gap and second gap. The tongue has an upper surface which may be curved upward or downward slightly.

An inner recess may be formed in the inner portion of the cavity, adapted to receive the edge of the cookware rim.

Thus, in use, in one motion the user can start to place the lid hook over the rim of the cookware item, and the surfaces of the base portion, upper portion, and central tongue, will easily guide the rim into the narrowest part of the first gap, the second gap, and finally the recess, in which position the cookware lid is stably supported on the rim. Multiple steps or manual manipulation of the lid hook are not required. The lid hook as shown does not use any kind of a springing, bending or deflection force to clamp the lid hook onto the rim.

Accordingly, in an aspect of the subject technology, a cookware set comprises a cookware vessel having a rim, a lid having an edge and a center, the lid configured to fit on and cover the cookware vessel in a first position, and a lid hook disposed on an upper surface of the lid at or near the edge of the lid and configured to support the lid in a substantially vertical position on a rim of the cookware vessel in a second position. The lid hook comprises a base member attached to the lid and an upper member extending over base member to define a cavity therebetween for receiving the rim of the cookware vessel. The cavity has an outer portion disposed toward the edge of the lid and an inner portion disposed toward the center of the lid, the cavity having a first gap between the base member and the upper member which is wide at the outer portion and narrow at the inner portion. A tongue disposed in the cavity on the base member defining a second gap between the tongue and the upper member. The cavity, first gap, and second gap are configured to guide the edge of the lid to a stable resting position so that the lid is supported on the rim of the cookware vessel in a second position.

### BRIEF DESCRIPTION OF THE DRAWINGS

FIG. 1 is a perspective view of a non-limiting embodiment of a lid hook according to the subject technology.

FIG. 2 is a front view of the lid hook of FIG. 1.

FIG. 3 is an elevation view of the lid hook of FIG. 1.

FIG. 4 is a perspective view of a non-limiting embodiment of a cookware lid with the lid hook of FIG. 1.

FIG. 5 is an elevation view of the cookware lid of FIG. 4.

FIG. 6 is the elevation view of FIG. 3 with the tongue deleted from the Figure to show features of the lid hook cavity more clearly.

FIG. 7 is a cross-sectional view of the cookware lid of FIG. 4 supported by the lid hook on the rim of a cookware vessel.

FIG. 8 is a cross-sectional view of the lid hook of FIG. 1, through a center plane of the lid hook, to show features of the tongue more clearly.

### DETAILED DESCRIPTION OF THE SUBJECT TECHNOLOGY

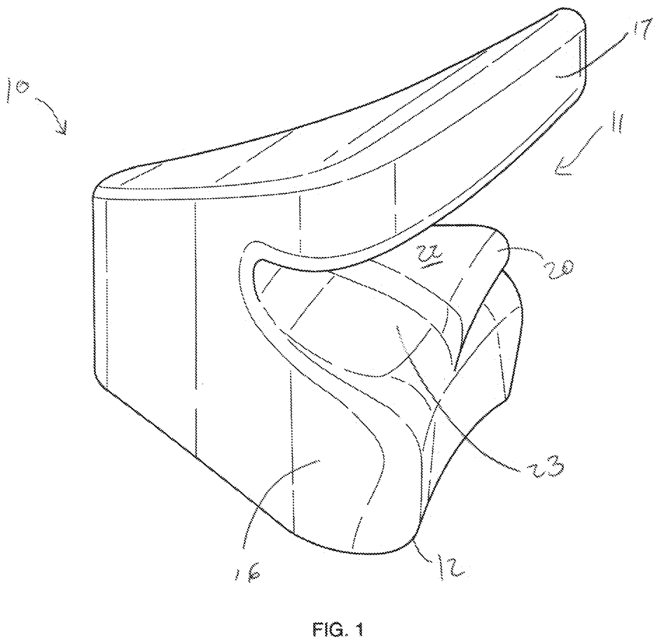

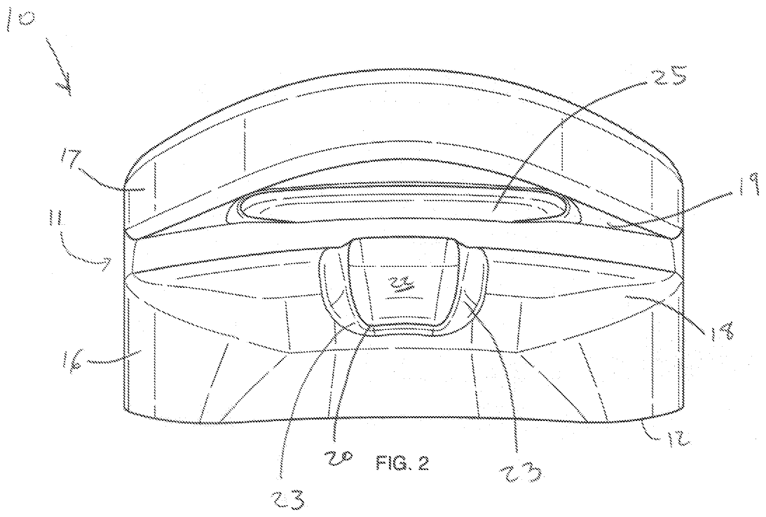

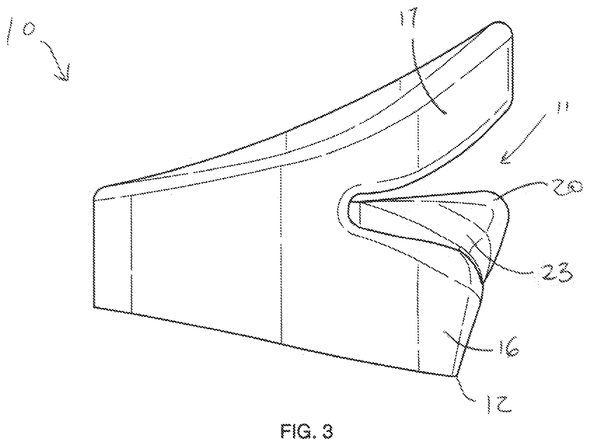

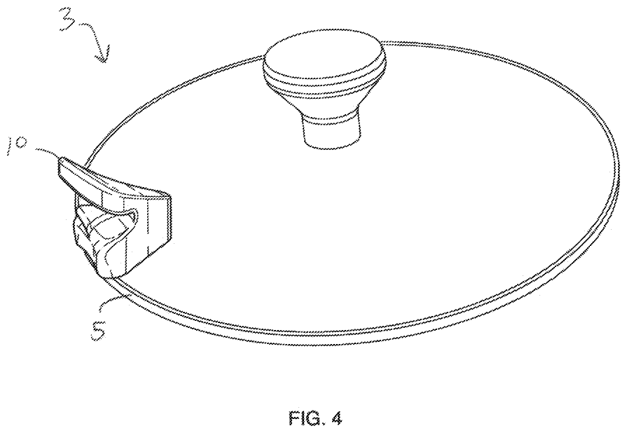

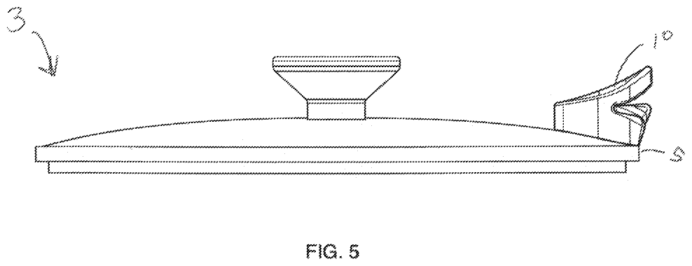

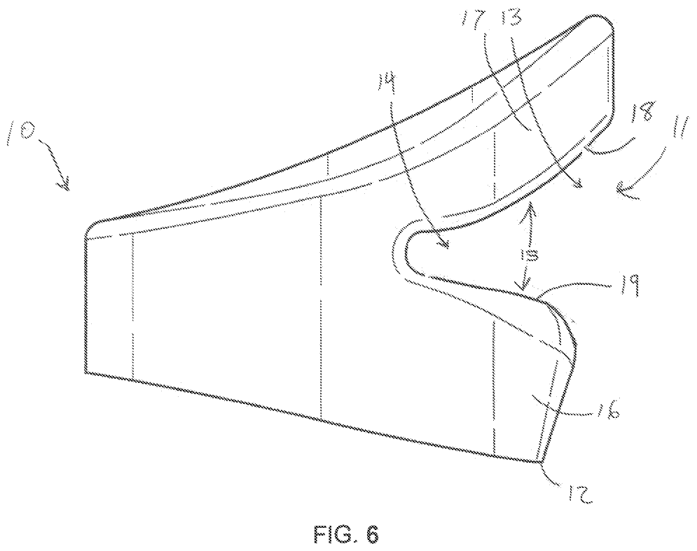

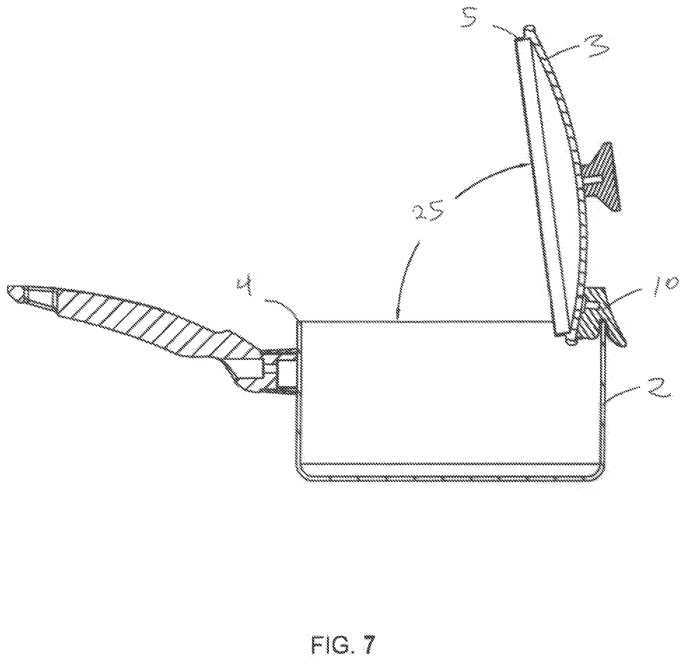

According to non-limiting embodiment of the subject technology, as shown for example in FIGS. 1-8, a cookware set comprises a cookware vessel 2 having a rim 4 and paired with a fitting cookware lid 3 having an edge 5. Lid hook 10 is disposed at or near edge 5, and is attached to cookware lid 3 by, for example, a through-going fastener, or by adhesive, or similar permanent attachment.

Lid hook 10 as shown is in the form of a unitary block of plastic material, but other materials could be used, for example, aluminum, steel, or other metal. Lid hook 10 is generally wedge-shaped, as shown in the Figures, and is formed with a cavity 11, which is open on an edge 12 of the lid hook 10 adjacent to the edge of the lid 3. Cavity 11 has an outer portion 13 (toward the edge of the lid 3) and an inner portion 14 (toward the center of the lid 3).

Cavity 11 defines a first gap 15 between base member or floor 16 (attached to the lid 3) and an upper member or roof 17 extending over base member 16, with first gap 15 therebetween. First gap 15 has a width (in the vertical direction between base member 16 and upper member 17) which is wider in the outer portion 13 and narrower in the inner portion 14, so that in use, it is easy for the user to initially place lid hook 10 over the rim 4 of cookware vessel 2 (because outer portion 13 of first gap 15 is relatively wide compared to the thickness of rim 4). First gap 15 is curved to accommodate the curvature of the cookware rim 4. In the embodiment shown, upper member 17 has an inner surface 18 which curves upward, and base member 16 has an inner surface 19 which curves downward, thereby achieving the first gap 15 with its widths as described.

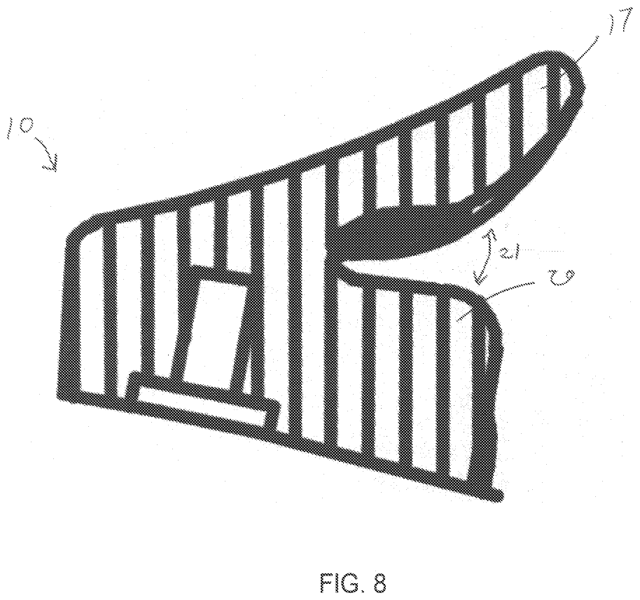

In use, as the user places lid hook 10 over rim 4, the rim 4 is introduced first into the outer (relatively wide) portion 13 of cavity 11, and as it settles further down, into the inner (relatively narrow) portion 14, and ultimately guide lid 3 into a stable support position on rim 4, which is best seen in FIG. 8. The lid 3 and rim 4 will form an angle 25, which is preferably less than 90 degrees, and in the non-limiting embodiment shown, is in the range of 75-85 degrees, more specifically, 80 degrees.

In the non-limiting embodiment shown, cavity 11 of lid hook 10 has disposed therein tongue 20, located on a center line of base portion 16. Tongue 20 is narrower in width than the base portion 16, and defines a second gap 21 between an upper surface 22 of the tongue 20 and inner surface 18 of upper member 17. In the embodiment shown, tongue 20 has angled edges 23 on the left and right sides thereof, which tend to guide rim 4 into the narrowest parts of the first gap 15 and second gap 21. Tongue 20 has an upper surface 22 which may be curved upward or downward slightly.

An additional feature of the non-limiting embodiment shown is recess 25, which is formed in inner portion 14. Recess 25 is shaped and configured to receive and retain an edge of cookware vessel rim 4, as its ultimate destination.

Thus in the embodiment shown, in use, in one motion the user can start to place lid hook 10 over rim 4 of cookware item 2, and the surfaces of the base portion 16, upper portion 17, and central tongue 20, will easily guide rim 4 into the narrowest part of the first gap 15 and second gap 21, and finally into the recess 25, in which position the cookware lid 3 is stably supported on rim 4 of cookware vessel 2. Multiple steps, or manual manipulation of the lid hook is not required. The lid hook 10 as shown does not use any kind of a springing, bending or deflection force to clamp the lid hook 10 onto the rim 4, and instead utilizes the novel geometry of lid hook 10 to enable easy stowage of lid 3.

In an embodiment, the support 10 is a single, unitary piece of a material suitable for use in cookware, for example, steel, aluminum, or other metal, or heat-resistant plastic and may be manufactured by, for example, by injection molding or 3D printing.

While specific embodiments of the subject technology have been shown and described in detail to illustrate the application of the principles of the subject technology, it will be understood that the invention may be embodied otherwise without departing from such principles. It will also be understood that the present subject technology includes any combination of the features and elements disclosed herein and any combination of equivalent features. The exemplary embodiments shown herein are presented for the purposes of illustration only and are not meant to limit the scope of the subject technology.

What is claimed is:

1. A cookware set comprising:
a cookware vessel having a rim;
a lid having an edge and a center, the lid configured to fit on and cover the cookware vessel in a first position; and
a lid hook disposed on an upper surface of the lid at or near the edge of the lid and configured to support the lid in a substantially vertical position on the rim of the cookware vessel in a second position, the lid hook comprising a base member attached to the lid and an upper member extending over base member to define a cavity therebetween for receiving the rim of the cookware vessel;
the cavity having an outer portion disposed toward the edge of the lid and an inner portion disposed toward the center of the lid, the cavity having a first gap between the base member and the upper member which is wide at the outer portion and narrow at the inner portion;
a tongue disposed in the cavity on the base member defining a second gap between the tongue and the upper member;
wherein the cavity, first gap, and second gap are configured to guide the edge of the lid to a stable resting position so that the lid is supported on the rim of the cookware vessel in a second position.

2. The cookware set of claim 1 wherein the lid hook is a single unitary block of metal or polymer.

3. The cookware set of claim 1 wherein the tongue has formed thereon angled edges for guiding the edge of the lid into the second gap.

4. The cookware set of claim 1 wherein the inner portion of the cavity has an inner recess adapted to receive an edge of the cookware rim.

5. The cookware set of claim 1 wherein the lid hook is attached to the lid by a fastener or by adhesive.

6. The cookware set of claim 1 wherein, when supported in the second position, the lid and the rim of the cookware vessel form an angle less than 90 degrees.

7. The cookware set of claim 1 wherein, when supported in the second position, the lid and the rim of the cookware vessel form an angle in the range of 75-85 degrees.

8. The cookware set of claim 1 wherein, when supported in the second position, the lid and the rim of the cookware vessel form an angle of 80 degrees.

9. The cookware set of claim 1 wherein the lid hook does not use a springing, bending or deflection force to clamp the lid hook onto the rim of the cookware vessel.
